(19) United States
(12) Patent Application Publication
(10) Pub. No.: US 2006/0274536 A1
(43) Pub. Date: Dec. 7, 2006

(54) Adding a lighting apparatus to an existing recessed lighting can

(76) Inventor: Robert Eugene Hagen SR., Ozark, MO (US)

Correspondence Address: Mr. Walter J. Tencza Jr., Suite 3, 10 Station Place, Metuchen, NJ, 08840, US

(21) Appl. No.: 11/146,323

(22) Filed: Jun. 6, 2005

(51) Int. Cl. F21S 8/06

(52) U.S. Cl. 362/404; 362/147; 362/365

(57) ABSTRACT

An apparatus is provided including a trim adapted to connect to a recessed lighting container so that the trim lies outside of a recessed chamber of the container. The apparatus also includes a member connected to the trim, so that when the trim is connected to a first end of the recessed lighting container, the member does not extend into the recessed chamber. A lighting device is connected to the member, so that the lighting device does not extend into the recessed chamber when the trim is connected to the first end of the recessed lighting container.

### FIELD OF THE INVENTION

This invention relates to improved methods and apparatus concerning lighting devices.

### BACKGROUND OF THE INVENTION

Typically in the prior art existing lighting devices are removed when a new lighting device is to be installed.

### SUMMARY OF THE INVENTION

The present invention in one or more embodiments includes an apparatus comprising a trim adapted to connect to a recessed lighting container, such as a domed cylindrical can, so that the trim lies outside of a recessed chamber of the recessed lighting container. The recessed lighting container has a first end and a second end, the recessed chamber between the first end and the second end, and a first diameter. The trim has a second diameter, which is about equal to or greater than the first diameter of the recessed lighting container. The trim when connected to the first end of the recessed lighting container substantially covers the first end of the recessed lighting container.

The apparatus also includes a member connected to the trim, so that when the trim is connected to the first end of the recessed lighting container, the member does not extend into the recessed chamber. The apparatus also includes a lighting device connected to the member, so that the lighting device does not extend into the recessed chamber when the trim is connected to the first end of the recessed lighting container.

The apparatus may also include one or more clips for connecting the trim to the recessed lighting container. The member may be elongated and the member may have a first end connected to the trim substantially at the center of the trim. The member may have second end connected to the lighting device. The lighting device may have a diameter. The member may have a length and a width, and the width of the member may be substantially less than the diameter of the lighting device.

The apparatus may also include a lamp within the lighting device and a transformer. The lamp may be electrically connected to the transformer. The transformer may receive alternating current of, for example, one hundred and twenty volts and transform the one hundred and twenty volts alternating current into twelve-volt alternating current. The apparatus may also include a male electrical socket. The male electrical socket may be electrically connected to the lamp, so that when the male electrical socket is plugged into a female electrical socket supplying power, the lamp can be turned on. The apparatus may also include a swivel device connected to the lighting device. The swivel device may allow the lighting device to swivel with respect to the trim.

The present invention may include a method comprising connecting a trim to a recessed lighting container, such as for example a recessed lighting cylindrical can, connecting a member to the trim, and connecting a lighting device to the member.

### BRIEF DESCRIPTION OF THE DRAWINGS

FIG. 1 shows a cross sectional view of an apparatus in accordance with an embodiment of the present invention;

FIG. 2 shows a cross sectional view of an apparatus in accordance with another embodiment of the present invention;

FIG. 3 shows a cross sectional view of an apparatus in accordance with another embodiment of the present invention;

FIG. 4 shows a cross sectional view of an apparatus in accordance with another embodiment of the present invention; and

FIG. 5 shows an upside down perspective view of an existing recessed lighting container and a trim in accordance with the present invention attached to the container, wherein the trim is shown in dashed lines.

### DETAILED DESCRIPTION OF THE DRAWINGS

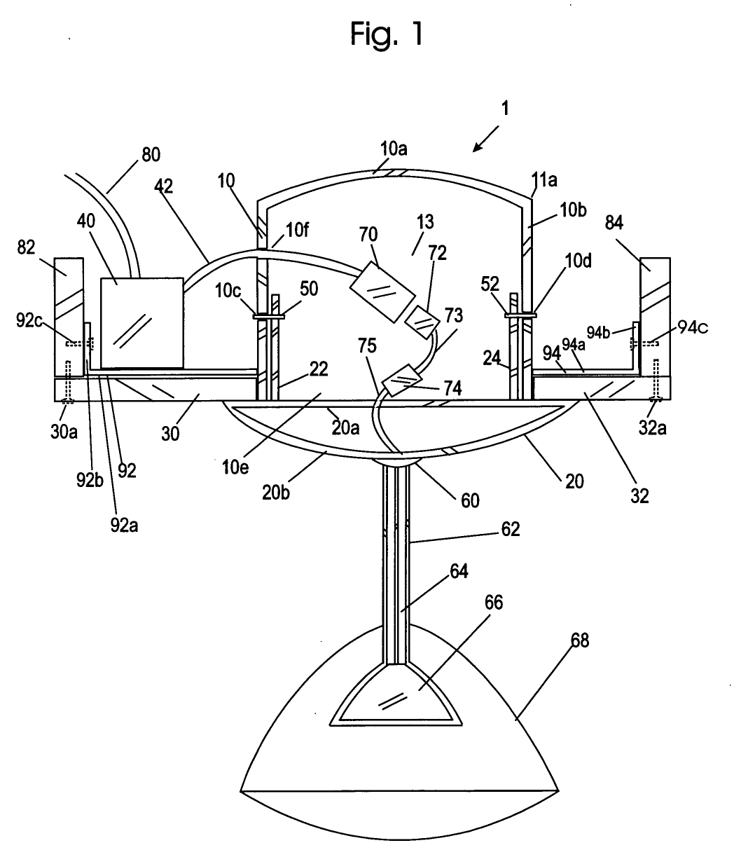

FIG. 1 shows a cross sectional view of an apparatus 1 in accordance with an embodiment of the present invention. The apparatus 1 includes a recessed container 10, a trim 20, joists 82 and 84, ceiling panels 30 and 32, a junction box 40, an attachment or connection device 60, a member 62, a lamp 66, and a lighting device 68. The recessed container 10 can be a typical existing recessed cylindrical can for recessed lighting as known in the art. The joists 82 and 84, ceiling panels 30 and 32, and junction box 40 are known in the art. The joists 82 and 84 are typically ceiling structural joists in a building.

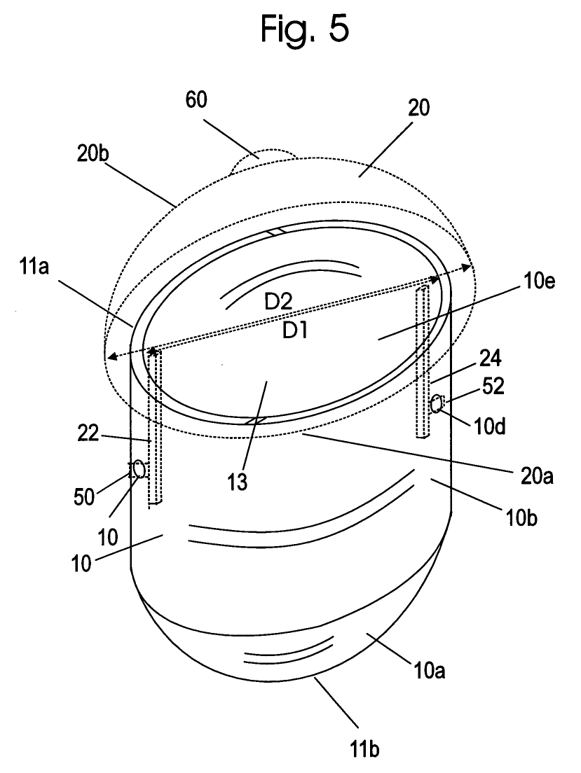

The recessed container 10 may have a curved or domed top wall 10a fixed or integrated with a cylindrical wall 10b. The cylindrical wall 10b may have eyelets or openings 10c and 10d. The recessed can 10 includes a recessed chamber 13, which is surrounded by the top wall 10a, the cylindrical wall 10b, and an end 10e, which may be at least partially opened. FIG. 5 shows an upside down view of the recess container 10 along with attached trim 20. The attached trim 20 is shown in dashed lines. The recessed container 10 has a first end 11a and a second end 11b shown in FIG. 5. The end 10e may be covered at least partially by a flat portion 20a of the trim 20. The trim may also have a domed portion 20b, which may partially or fully cover the opening or end 10e.

The recessed container 10 may be fixed to structural joists 82 and 84, through brackets 92 and 94 respectively in a manner known in the art. The bracket 92 may be L-shaped and may include portion 92a and portion 92b. The portion 92b may be fixed to the joist 82 by fastener 92c, which may be a screw or nail. The bracket 94 may also be L-shaped and may include portion 94a and portion 94b. The portion 94b may be fixed to the joist 94 by fastener 94c, which may be a screw or nail.

The ceiling panel 30 is fastened to the joist 82 by fasteners such as fastener 30a and the panel 30 may be fastened by a further number of fasteners not shown or to a further number of joists not shown. Similarly ceiling panel 32 is fastened to the joist 84 by fasteners such as fastener 32a and the panel 32 may be fastened by further number of fasteners not shown or to a further number of joists not shown. The ceiling panels may be drywall panels, gypsum board panels, or sheetrock panels. The ceiling panels 30 and 32 may actually be one integrated ceiling panel in which there is a hole for the opening 10e shown in FIG. 5 of the recessed container 10. The trim 20 is connected to the recessed container 10 by metal support clips 22 and 24 and eyelets 50 and 52. Clip 22 is connected to recessed container 10 by eyelet 50 through opening 10c in cylindrical wall 10b of the recessed can 10. Clip 24 is connected to recessed can 10 by eyelet 52 through opening 10d in recessed can 10.

The junction box 40 may be fixed to the bracket 92 as shown in FIG. 1. A one hundred and twenty volt AC power supply or power cord 80 may be electrically connected to the junction box 40. A cord 42 may be electrically connected to the cord 80 and the cord 42 may pass through an opening 10f in the recessed container 10. A thermal protection device, not shown and known in the art, may be located inside the recessed container 10 at the location of the opening 10f. The cord 42 is electrically connected to a female socket 70. Also shown in FIG. 1 is a male socket 72 which can be inserted into the female socket 70. The male socket 72 is electrically connected to a cord 73, which is electrically connected to a twelve-volt A.C. transformer 74. The cord 73 may actually include two wires such as one hot or black wire (wire conductor covered with black colored insulation) and one white or ground wire (wire conductor covered with white colored insulation). The twelve-volt A.C. transformer 74 is electrically connected to a cord 75, which passes through an opening in connection device 60 and is electrically connected to a stem 64. The stem 64 is electrically connected to lamp 66. The cord 75 may actually be comprised of a hot or black wire (conductor wire covered with black colored insulation) and a ground or white wire (conductor wire covered with white colored insulation). The cord 75 may be comprised of two sections which need to be electrically connected together, with one section connected to the transformer and the other section connected to the stem 64. The two sections of cord 75 can be connected by wire nuts or other approved means.

Lamp 66 may be a fifty-watt MR-16 lamp. Numerous other lamps could be used. The lighting device 68 surrounds the lamp 66. The lighting device 68 may be a pendant lighting device of any shape, size, or color, which can be coordinated with a particular decor. The combination of member 62, stem 64, lamp 66, and lighting device 68 may be considered a pendant lighting device or part of a pendant lighting device.

The member 62 may be a hollow rigid tube having a ¼ inch to ⅜ of an inch diameter and may be made of metal or a rigid strong plastic. The member 62 also may be a cord. The connection device 60 connects the member 62 to the trim 20 substantially centrally.

The trim 20 and the member 62 allow an existing recessed container, such as recessed cylindrical can 10 to be used for hanging a pendant lighting device, such as including the device 68.

FIG. 5 shows an upside down perspective view of the existing recessed lighting container, or cylindrical can 10 and the trim 20 attached to the container 10, wherein the trim 20 is shown in dashed lines. For ease of description, the other components shown in FIG. 1 have been eliminated from FIG. 5. FIG. 5 shows clips 22 and 24 attached by eyelets 50 and 52 through openings 10c and 10d, respectively, to attach the trim 20 to the container 10. FIG. 5 also shows the portion 20b of the trim 20. The portion 20b may be domed or curved as shown or may be flat. FIG. 5 also shows that the diameter of the recessed chamber 13 is D1 and the outside diameter of the trim 20 is D2, which is larger than D1 so that the trim 20 covers the opening 10e to the recessed chamber 13.

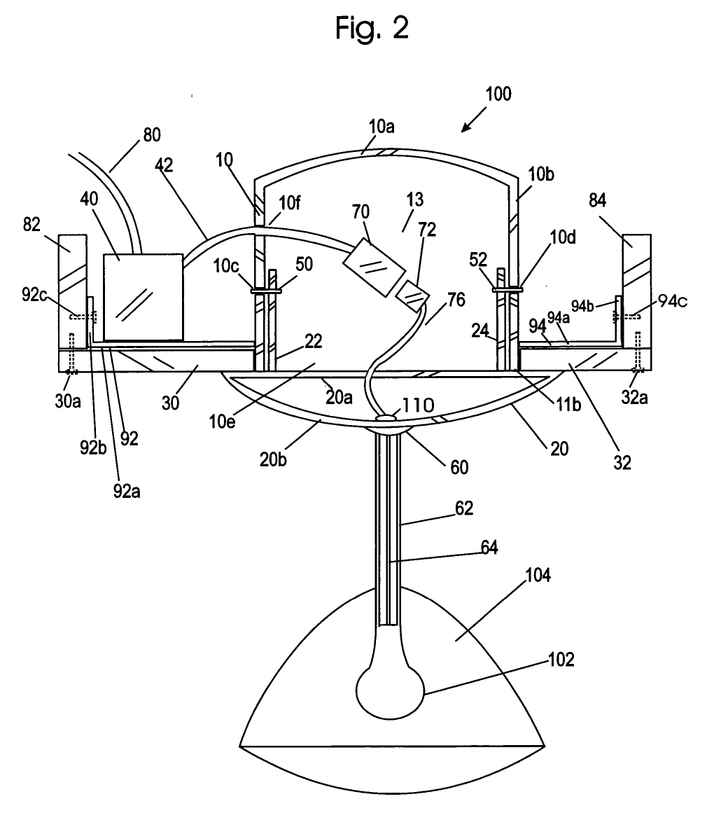

FIG. 2 shows a cross sectional view of an apparatus 100 in accordance with another embodiment of the present invention. The apparatus 100 is similar to the apparatus 1 of FIG. 1. The apparatus 100 includes the recessed container 10, the trim 20, the ceiling panels 30 and 32, the joists 82 and 84, the brackets 92 and 94, the junction box 40, the attachment device 60, and the member 62.

The trim 20 for apparatus 100 is connected to the recessed container 10 as in FIG. 1. However, unlike the apparatus 1, the male socket 72, in FIG. 2, is electrically connected to a cord 76, which is electrically connected to the stem 64. There is no transformer 74 in the embodiment of FIG. 2. Also the stem 64 in FIG. 2 is electrically connected to a 120-volt halogen type mini can lamp 102, which is housed in a lighting device 104. Numerous other 120 volt lamps could also be used instead of lamp 102. The components 60, 62, 64, 102 and 104 may together be considered a pendant lighting device or part of a pendant lighting device.

FIG. 2 also shows a crimp ring 110 which can be installed to hold the cord 76 in place. In the embodiment of FIG. 2, the member 62 can be a cord or a pendant stem. Existing pendant stems in the prior art, typically come in twelve-inch or six inch sections with one-quarter (¼) inch nipple threads (female and males ends to put together stem for pendant stem section for different lengths).

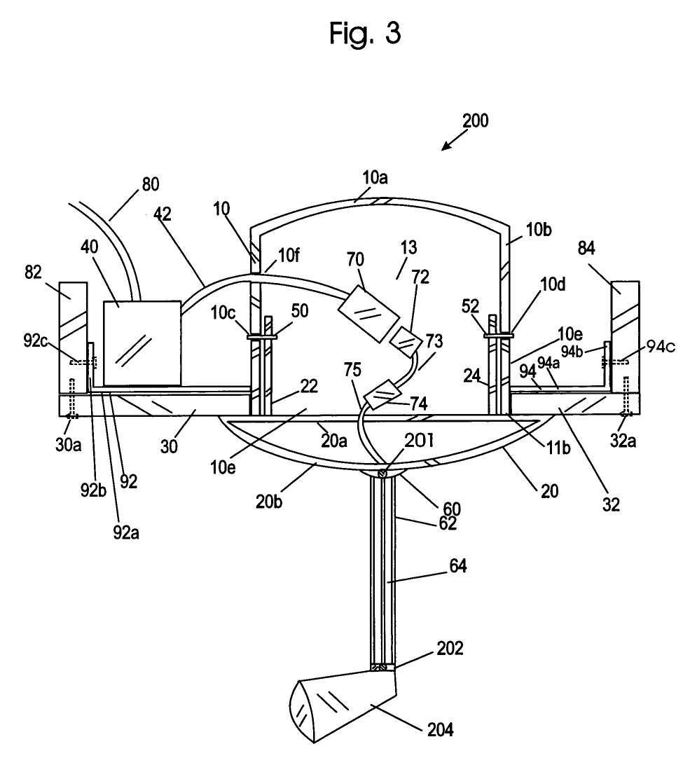

FIG. 3 shows a cross sectional view of an apparatus 200 in accordance with another embodiment of the present invention. The apparatus 200 is similar to the apparatus 1 of FIG. 1. The apparatus 200 includes the recessed container 10, the trim 20, the ceiling panels 30 and 32, the joists 82 and 84, the brackets 92 and 94, the junction box 40, the attachment device 60, and the member 62. The apparatus 200 also includes the cords 42, 73, and 75, stem 64, the female socket 70, the male socket 72 and the transformer 74.

However, unlike the apparatus 1, the stem 64 in FIG. 3 is electrically connected to a swivel type lighting device 204. The swivel type lighting device is attached to the member 62 via a swivel device 202 which may allow for titling of the lighting device 204 and panning of the lighting device 204. In the FIG. 3 embodiment, the device 60 may also swivel or may include a swivel device or axis 201 which may be part of the attachment device 60. The swivel device or axis 201 may be used for sloped ceilings to allow the member 62 to hang straight down, perpendicular to a level ground surface. The member 62 would typically be an existing stem for a pendant lighting device known in the art.

The lighting device 68 of FIG. 2 and the member 62 may be called or may be part of a pendant hanging light fixture. The present invention allows such pendant hanging light fixtures to be hung from existing recessed containers or can fixtures. The method of one embodiment of the present invention transforms recessed lighting into hanging pendant lighting fixtures. The member 62 can be a metal stem or cord depending on the application.

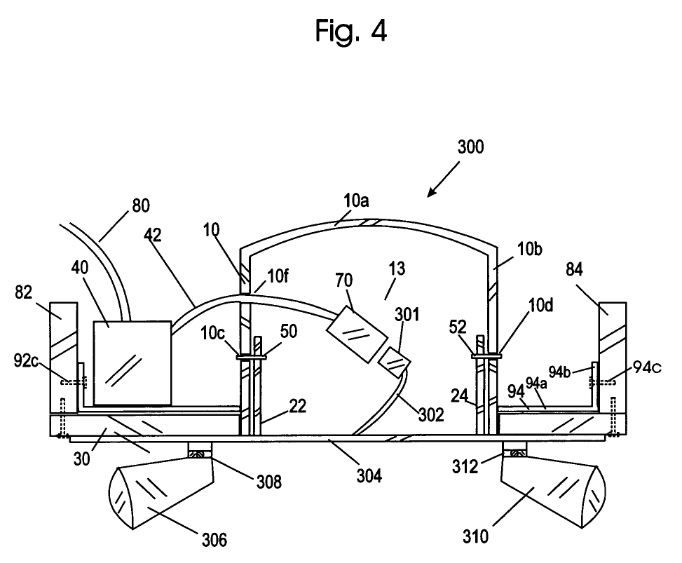

FIG. 4 shows a cross sectional view of an apparatus 300 in accordance with another embodiment of the present invention. The apparatus 300 is in some respects similar to the apparatus 1 of FIG. 1. The apparatus 300 includes the recessed container 10, the ceiling panels 30 and 32, the joists 82 and 84, the brackets 92 and 94, the junction box 40, and the eyelets 50 and 52. The apparatus 200 also includes the cord 42 and the female socket 70. The cord 42 running from the junction box 40 to the recessed container 10 may actually be comprised of two wires in a protected flexible metal conduit as known in the art. The two wires within cord 42 would typically include one black or hot wire (a wire covered with black colored insulation) and one grounded or white wire (a wire covered with white colored insulation).

However, unlike the apparatus 1, in the apparatus 300 a male socket 301 is electrically connected by a cord 302 to a track 304. The track 304 is structurally connected to the recessed lighting container 10 by clips 22 and 24, which are held by eyelets 50 and 52. Lighting devices 306 and 310 are electrically connected to the track 304 through devices 308 and 312 respectively. The devices 308 and 312 may allow the lighting devices 306 and 310 to swivel, including allowing panning and tilting.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a trim adapted to connect to a recessed lighting container;
wherein the recessed lighting container has a first end and a second end, with a recessed chamber between the first end and the second end;
wherein the recessed chamber has a first dimension;
wherein the trim has a second dimension, which is about equal to or greater than the first dimension, so that the trim lies outside of the recessed chamber and covers at least a portion of the second end of the recessed lighting container when connected to the second end of the recessed lighting container;
a member connected to the trim, so that when the trim is connected to the second end of the recessed lighting container, the member does not extend into the recessed chamber; and
a lighting device connected to the member, so that the lighting device does not extend into the recessed chamber when the trim is connected to the second end of the recessed lighting container.

2. The apparatus of claim 1 wherein
the recessed lighting container is a substantially cylindrical can.

3. The apparatus of claim 2 further comprising
one or more clips for connecting the trim to a cylindrical wall of the substantially cylindrical can.

4. The apparatus of claim 1
wherein the member is elongated and the member has a first end connected to the trim substantially at the center of the trim and the member has a second end connected to the lighting device.

5. The apparatus of claim 1 wherein
the lighting device has a diameter; and
wherein the member is elongated and the member has a length and a width, and the width of the member is substantially less than the diameter of the lighting device.

6. The apparatus of claim 1 further comprising
a lamp within the lighting device; and
a transformer;
wherein the lamp is electrically connected to the transformer; and
wherein the transformer receives 120 volts alternating current and transforms the 120 volt alternating current into 12 volt alternating current.

7. The apparatus of claim 1 further comprising
a lamp within the lighting device; and
a male electrical socket;
wherein the male electrical socket is electrically connected to the lamp, so that when the male electrical socket is plugged into a female electrical socket supplying power, the lamp can be turned on.

8. The apparatus of claim 1 further comprising
a swivel device connected to the lighting device; and
wherein the swivel device allows the lighting device to swivel with respect to the trim.

9. The apparatus of claim 1 wherein
the member forms a track and a plurality of track lighting devices can be inserted into the track.

10. The apparatus of claim 9 wherein
the member and the trim are integrated together.

11. A method comprising:
connecting a trim to a first end of a recessed lighting container so that the trim substantially covers the first end of the recessed lighting container;
wherein the recessed lighting container has a first end and a second end and a recessed chamber between the first end and the second end;
wherein the recessed chamber has a first dimension;
wherein the trim has a second dimension, which is about equal to or greater than the first dimension; and further comprising
connecting a member to the trim so that when the trim is connected to the first end of the recessed lighting container, the member does not extend into the recessed chamber; and
connecting a lighting device to the member, so that the lighting device does not extend into the recessed chamber when the trim is connected to the first end of the recessed lighting container.

12. The method of claim 11 further comprising
connecting one or more clips to the trim to connect the trim to the recessed lighting container.

13. The method of claim 11
wherein the member is elongated and further comprising
connecting a first end of the member to the trim substantially at the center of the trim and connecting a second end of the member to the lighting device.

14. The method of claim 11 wherein
the lighting device has a diameter;
the member is elongated and the member has a length and a width, and the width of the member is substantially less than the diameter of the lighting device.

15. The method of claim 11 wherein
a lamp is located within the lighting device; and further comprising
electrically connecting a transformer to the lamp;
wherein the transformer transforms 120-volt alternating current into 12-volt alternating current.

16. The method of claim 11 wherein
a lamp is located within the lighting device; and
electrically connecting a male electrical socket to the lamp, so that when the male electrical socket is plugged into a female electrical socket supplying power, the lamp can be turned on.

17. The method of claim 11 further comprising
connecting a swivel device to the lighting device;
wherein the swivel device allows the lighting device to swivel with respect to the trim.

18. The method of claim 11 wherein
the member forms a track and a plurality of track lighting devices can be inserted into the track.

19. The method of claim 11 wherein
the member and the trim are integrated together.
